(19) United States
(12) Patent Application Publication
(10) Pub. No.: US 2011/0216090 A1
(43) Pub. Date: Sep. 8, 2011

(54) REAL-TIME INTERACTIVE AUGMENTED REALITY SYSTEM AND METHOD AND RECORDING MEDIUM STORING PROGRAM FOR IMPLEMENTING THE METHOD

(75) Inventors: Woon Tack WOO, Gwangju (KR); Ki Young Kim, Gwangju (KR); Young Min Park, Gwangju (KR); Woon Hyuk Baek, Gwangju (KR)

(73) Assignee: Gwangju Institute of Science and Technology, Gwangju (KR)

(21) Appl. No.: 12/968,070

(22) Filed: Dec. 14, 2010

(30) Foreign Application Priority Data
Mar. 3, 2010 (KR) 10-2010-0019047

(51) Int. Cl. G09G 5/00; G06K 9/00

(52) U.S. Cl. 345/633; 382/103

(57) ABSTRACT

The present invention relates to a real-time interactive system and method regarding an interactive technology between miniatures in real environment and digital contents in virtual environment, and a recording medium storing a program for performing the method. An exemplary embodiment of the present invention provides a real-time interactive augmented reality system including: an input information acquiring unit acquiring input information for an interaction between real environment and virtual contents in consideration of a planned story; a virtual contents determining unit determining the virtual contents according to the acquired input information; and a matching unit matching the real environment and the virtual contents by using an augmented position of the virtual contents acquired in advance. According to the present invention, an interaction between the real environment and the virtual contents can be implemented without tools, and improved immersive realization can be obtained by augmentation using natural features.

### BACKGROUND OF THE INVENTION

1. Field of the Invention

The present invention relates to a real-time interactive augmented reality system and method and a recording medium storing a program for implementing the method. More particularly, the present invention relates to a real-time interactive system and method regarding interactive technology between a miniature of real environment and digital contents in virtual environment, and a recording medium storing a program for implementing the method.

2. Description of the Related Art

Recently, interest in digilog type contents is increasing. The digilog type contents are defined in a form of seamless integration between digital contents and conceptually analog objects. The digilog type contents have an advantage of making it possible to experience unique information which analog objects are trying to give together with virtual multimedia information generated through a computer. Digilog books into which analog books and digital information on the contents of the books converge in augmented reality space are representative examples of the digilog type contents.

Augmented reality is a hybrid technology most appropriate for reproducing digilog type applications. In the augmented reality, in particular, real-time camera tracking technology for obtaining real environment information into which virtual contents is to be inserted and interactive technology for providing seamless augmented reality are very appropriate for reproducing digilog type applications.

In the related art, various camera tracking methods for augmented reality have been researched. Representatively, ARToolKit is widely used. In the case of ARToolKit, the creation of augmented reality applications in which interaction in small-scale work space is emphasized is easy; however, there are disadvantages in which the creation of application systems in large space is difficult and typical black square markers disrupt the immersive realization of users. In order to make up for the disadvantages of the ARToolKit, researches on marker-less tracking have been conducted. The marker-less tracking provides natural augmentation by using actual environment information instead of markers. However, since the marker-less tracking technology requires more complicated initializing work and a larger amount of computation as compared to the ARToolKit, there is a limit in the real-time performance. In particular, use of the geometric information on actual space is insufficient.

Meanwhile, in order to implement seamless augmented reality, not only the real-time camera tracking technology but also the interactive technology enabling a user to naturally interact with augmented virtual contents are necessary. However, in systems using the existing marker-less tracking technology, interaction is not considered, and most systems still use interaction using tools with markers. In the case of using tools with markers, it is possible to easily implement the tracking technology but it is difficult to implement natural interaction.

### SUMMARY OF THE INVENTION

The present invention has been made in an effort to provide a real-time interactive augmented reality system and method which merge and reproduce analog miniatures and digital contents in augmented reality space in real time and implement an interactive method using a 3D real-time depth camera and a marker-less real-time camera tracking method through the miniature AR, and a recording medium storing a program for implementing the method.

An exemplary embodiment of the present invention provides an interactive augmented reality system including: an input information acquiring unit acquiring input information for an interaction between real environment and virtual contents in consideration of planned story; a virtual content determining unit determining the virtual contents according to the acquired input information; and a tracking unit matching the real environment and the virtual contents and performing tracking in real time by using an augmented position of the virtual contents acquired in advance.

The interactive augmented reality system may further include a virtual contents authoring unit authoring the virtual contents on the basis of a GUI (graphical user interface). The virtual contents authoring unit may include a virtual contents aligning unit aligning the virtual contents to be proportion to the sizes of objects in the real environment when authoring the virtual contents. The virtual contents aligning unit may include an augmented position setting unit setting an augmented position of virtual contents, a virtual contents loading unit loading the virtual contents to the set augmented position, a scale setting unit determining a scale of the loaded virtual contents, and a pose setting unit determining the pose of the virtual contents on which the scale setting has been performed. The scale setting unit may set the scale to a value obtained by dividing a length of an edge of the virtual contents by a length of a corresponding edge of the actual object.

The matching unit may include an interaction analyzing unit analyzing the interaction between the real environment and the virtual contents on the basis of depth information of at least one object positioned in the real environment.

The interactive augmented reality system may further include a position computing unit computing the augmented position of the virtual contents on the basis of features in an acquired image. The interactive augmented reality system may further include: a first feature matching unit comparing a restored image regarding the real environment and the acquired image and performing feature matching through the comparison, and a second feature matching unit comparing the previous image of the acquired image and the acquired image and performing feature matching through the comparison. When the position computing unit computes the augmented position, the first feature matching unit and the second feature matching unit may be driven at the same time.

The first feature matching unit may include: an object recognizing unit primarily recognizing at least one object having a scale equal to or greater than a reference value in the acquired image and secondarily recognizing at least one object a scale less than the reference value in the acquired image; a comparing unit adding the number of objects primarily recognized to the number of objects secondarily recognized and comparing the number of recognized objects with a predetermined limit value; a recognition control unit making the object recognizing unit recognize objects in the acquired image one more time if the number of recognized objects is greater than the limit value; a pose computing unit computing poses of the recognized objects by using the restored image if the number of recognized objects is not greater than the limit value; and an object information acquiring unit acquiring information on objects corresponding to inliers among the objects having been subject to the pose computation according to a coordinate system generating algorithm based on RANSAC (random sample consensus).

The second feature matching unit may include a determining unit determining whether an object acquired in advance is in the acquired image; a feature matching unit performing feature matching on the basis of an SIFT (scale invariant feature transform) algorithm if an object acquired in advanced is in the acquired image; a comparing unit comparing the number of matched features with a reference value; a pose computing unit computing a pose of an image acquiring device for acquiring images by using a previous image if the number of matched features is equal to or greater than the reference value; an image acquisition control unit making the image acquiring device acquire an image again if any object acquired in advance is not in the acquired image or the number of matched features is less than the reference value; and an object information acquiring unit acquiring information on objects corresponding to inliers in the acquired image by the image acquiring device on which the pose computation has been performed.

The position computing unit may include a feature detecting unit detecting the features by using color information of the acquired image, and a tracking unit tracking the position of an image acquiring device for acquiring images by using edge information of objects or 2D information of the objects in addition to the features.

The matching unit may use depth information of an acquired image or context information of the acquired image when performing matching of the virtual contents.

The position computing unit may include a feature detecting unit selectively detecting the features in uniform spaces on the basis of observation probabilities.

Another exemplary embodiment of the present invention provides a method of implementing an interaction in augmented reality including: (a) acquiring input information for an interaction between real environment and virtual contents in consideration of planned story; (b) determining the virtual contents according to the acquired input information; and (c) matching the real environment and the virtual contents by using an augmented position of the virtual contents acquired in advance.

The method of implementing an interaction in augmented reality may include (b1) authoring the virtual contents on the basis of a GUI (graphical user interface) between the (b) and the (c). The (b1) may align the virtual contents to be proportion to the sizes of objects in the real environment when authoring the virtual contents. The aligning of the virtual contents in the (b1) may include (b11) setting the augmented position, (b12) loading the virtual contents to the set augmented position, (b13) determining a scale of the loaded virtual contents, and (b14) determining the pose of the virtual contents on which the scale setting has been performed. The (b13) may set the scale to a value obtained by dividing a length of an edge of the virtual contents by a length of a corresponding edge of the actual object.

The method of implementing an interaction in augmented reality may include (b1) computing the augmented position on the basis of features in an acquired image between the (b) and the (c). The (b1) may include (b11) comparing a restored image regarding the real environment and the acquired image and performing feature matching through the comparison, and (b12) comparing the previous image of the acquired image and the acquired image and performing feature matching through the comparison. The (b11) and the (b12) may be performed at the same time when the (b1) computes the augmented position.

The (b11) may include (b11a) primarily recognizing at least one object having a scale equal to or greater than a reference value in the acquired image and secondarily recognizing at least one object a scale less than the reference value in the acquired image, (b11b) adding the number of objects primarily recognized to the number of objects secondarily recognized and comparing the number of recognized objects with a predetermined limit value, (b11c) making the object recognizing unit recognize objects in the acquired image one more time if the number of recognized objects is greater than the limit value, and computing poses of the recognized objects by using the restored image if the number of recognized objects is not greater than the limit value, and (b11d) acquiring information on objects corresponding to inliers among the objects having been subject to the pose computation according to a coordinate system generating algorithm based on RANSAC (random sample consensus).

The (b12) may include (b12a) determining whether an object acquired in advance is in the acquired image, (b12b) performing feature matching on the basis of an SIFT (scale invariant feature transform) algorithm if an object acquired in advanced is in the acquired image, and making the image acquiring device for acquiring images acquire an image again if any object acquired in advance is not in the acquired image, (b12c) comparing the number of matched features with a reference value, (b12d) computing a pose of an image acquiring device for acquiring images by using the previous image if the number of matched features is equal to or greater than the reference value, and making the image acquiring device acquire an image again if the number of matched features is less than the reference value, and (b12e) acquiring information on objects corresponding to inliers in the acquired image by the image acquiring device on which the pose computation has been performed.

When computing the augmented position, the (b1) may include detecting the features by using color information of the acquired image, and tracking the position of an image acquiring device acquiring the image by using the edge information of the object or the 2D information of the object in addition to the feature.

The (c) may use depth information of an acquired image or context information of the acquired image when matching the virtual contents.

The (b1) may include selectively detecting the features in uniform spaces on the basis of observation probabilities when computing the augmented position.

Yet another exemplary embodiment of the present invention provides a recording medium which is readable by a computer and stores a program for implementing any one of the above-mentioned methods.

According to the exemplary embodiments, the present invention has the following effects. First, a user can interact with 3D virtual contents matched with an actual miniature by using hands without arbitrary tools (e.g. a tool with a maker). Second, model information can be used to three-dimensionally render virtual shadow on an actual miniature when virtual contents are augmented and to resolve conflict between virtual and actual miniatures, and effects such as an occlusion phenomenon between virtual and actual miniatures can be obtained so as to enhance the immersive realization. Since all processes are performed on the basis of natural features, a better immersive realization can be obtained as compared to an approach using markers. Third, since virtual contents are augmented in consideration of actually measured ratio of miniatures, it is possible to establish a system based on actual measurement which has not been supported in existing augmented reality applications. Fourth, the proposed invention can be applied to not only miniatures but also existing outdoor buildings or indoor structures.

### BRIEF DESCRIPTION OF THE DRAWINGS

FIG. 1 is a block diagram schematically illustrating an interactive augmented reality system according to an exemplary embodiment of the present invention;

FIG. 2 is a view illustrating the general concept of a miniature AR system;

FIG. 3 is a detail view illustrating the inside of the interactive augmented reality system according to the exemplary embodiment of the present invention;

FIG. 4 is a reference diagram for explaining a virtual contents aligning process;

FIG. 5 is a flow chart illustrating an algorithm composed of a tracing thread and a recognizing thread;

FIG. 6 is a view illustrating results of interaction according to the exemplary embodiment of the present invention;

FIG. 7 is a view illustrating results obtained by augmenting a virtual avatar using 3D restoration and marker-less tracking results;

FIG. 8 is a view illustrating an example in which a plurality of augmented reality coordinate systems are generated in the real world by extending a marker-less tracking algorithm applied to miniature AR;

FIG. 9 is a view illustrating a procedure of demonstration of a miniature AR system; and

FIG. 10 is a flow chart illustrating a method of implementing interaction in augmented reality according to an exemplary embodiment of the present invention.

### DETAILED DESCRIPTION OF THE EMBODIMENTS

Hereinafter, exemplary embodiments of the present invention will be described in detail with reference to the accompanying drawings. It should be noted that identical or corresponding components are designated by the same reference numerals throughout the drawings throughout the drawings. Further, in this specification, a detailed description of related well-known structures or functions that may cloud the gist of the present invention is omitted. Furthermore, although the exemplary embodiments of the present invention will be described below, they are used in a generic and descriptive sense only and not for purposes of limitation of the technical spirit or scope of the invention. It will be apparent to those skilled in the art that modifications and variations can be made in the present invention without deviating from the spirit or scope of the present invention.

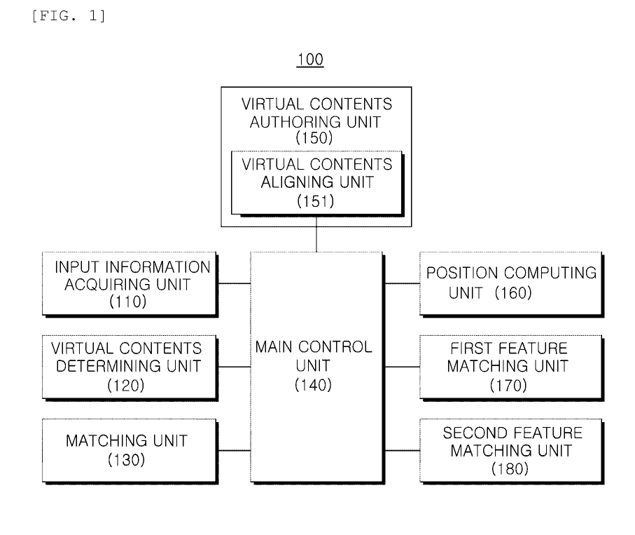

FIG. 1 is a block diagram schematically illustrating an interactive augmented reality system according to an exemplary embodiment of the present invention. Referring to FIG. 1, an interactive augmented reality system 100 includes an input information acquiring unit 110, a virtual contents determining unit 120, a matching unit 130, and a main control unit 140.

The interactive augmented reality system 100 according to the exemplary embodiment is defined as a miniature AR (augmented reality) system for experiencing augmented-reality-based digilog type contents. The interactive augmented reality system 100 implements a 3D-restoration-based marker-less real-time camera tracking method and a spatially interactive method using a 3D real-time depth camera. In particular, in the marker-less tracking technology, a user generates geometric information of miniatures and an interface using the geometric information for tracking is provided. 3D interaction supports direct and indirect spatial interaction with actual objects. The user can interact with 3D virtual contents matched to the actual miniatures with hands by using the proposed methods without arbitrary tools, and obtains enhanced immersive realization due to augmentation using natural features.

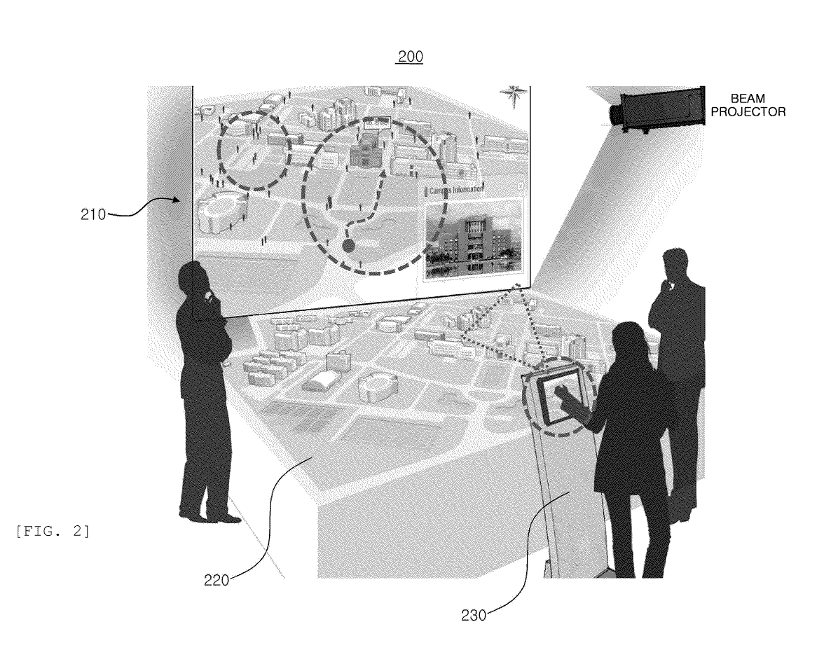

FIG. 2 shows a view illustrating the general concept of a proposed miniature AR system 200. The system 200 applies the augmented reality technology to a miniature of existing actual buildings or structures manufactured. The system 200 includes a screen unit 210 showing augmented results to a user, a miniature unit 220 in which spatial interaction between actual contents and the user occurs, a kiosk 230 for contents augmentation, etc. A general camera for inserting contents on a miniature is attached to the kiosk, and a depth camera 240 for supporting 3D interaction in a large area is installed on a ceiling. The kiosk 230 is movable as the user likes, and the depth camera 240 is designed to be connected to the miniature unit 220 and not to move if the system 200 is fixed.

The interactive augmented reality system 100 sequentially performs a camera image acquiring process, an image analyzing process, a registering process, a user input information acquiring process, an analyzing process, an applying process, an outputting process, etc., thereby implementing interactive augmented reality. Among them, in particular, the user input information acquiring process and the analyzing process are directly related to an interactive function.

The image analyzing process is a process of finding a feature from an acquired image. To this end, the image analyzing process performs feature tracking. In the registering process, a 3D reference coordination system is set. In the registering process, the 3D reference coordination system is made on the basis of the feature found through the image analyzing process, and in order to make the contents naturally look as if it is attached to the miniature, occlusion of a transparent virtual 3D miniature model on the actual miniature is performed. The user input information acquiring process implements interaction between the user and the contents according to a planned story. To this end, in the user input information acquiring process, a z-cam (depth camera), a joystick, a keyboard, a mouse, etc., are used as an input device. In the analyzing process, according to user input signals, corresponding contents according to a story are selected from among the prepared contents. The kinds of contents include 3D models, sounds, images, videos, etc. In the applying process, matching between the actual images and the contents is performed. In this case, the selected contents are superimposed at positions determined according to the coordinate systems made on the basis of the features found from the images.

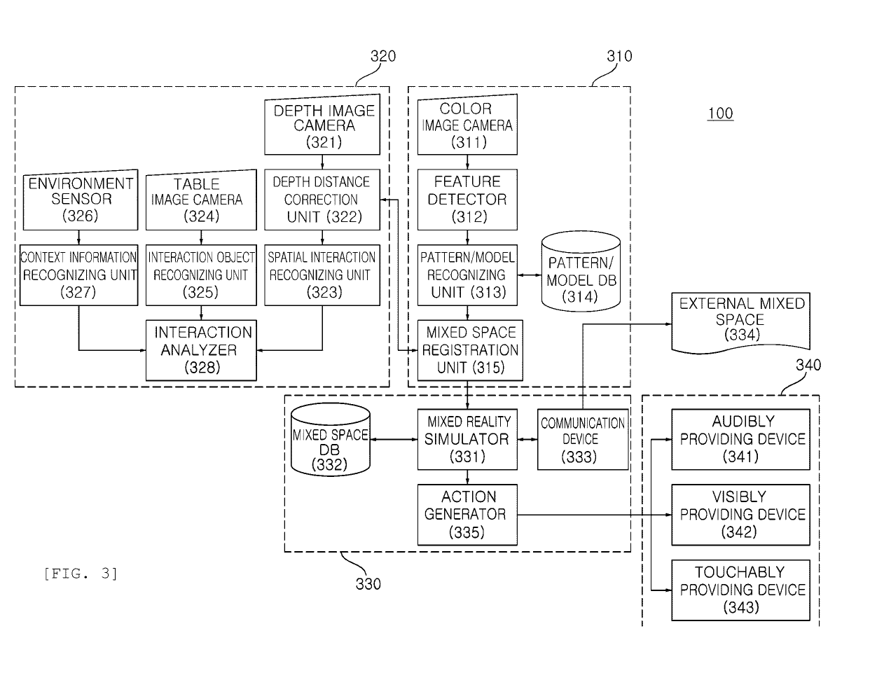

If the interactive augmented reality system 100 is generally divided into four constituent elements, it can be divided into a tracking module 310, an interaction module 320, a contents module 330, and a miniature AR module 340 as shown in FIG. 3.

The tracking module 310 is to track the camera, and includes a color image camera 311, a feature detector 312, a pattern/model recognizing unit 313, a pattern/model DB 314, and a mixed space registration unit 315. The interaction module 320 is to analyze interaction between real environment and virtual contents. In order to recognize spatial interaction, the interaction module 320 includes a depth image camera 321, a depth distance correction unit 322, a spatial interaction recognizing unit 323, etc. Further, in order to recognize an object for interaction, the interaction module 320 includes a table image camera 324, an interaction object recognizing unit 325, etc. In addition, in order to recognize context information, the interaction module 320 may include an environment sensor 326 capable of acquiring information on the intensity of illumination, pressure, sound, RFID, etc., a context information recognizing unit 327, etc. The interaction module 320 uses an interaction analyzer 328 to analyze the interaction between the real environment and the virtual contents on the basis of information obtained through the spatial interaction recognizing unit 323, the interaction object recognizing unit 325, the context information recognizing unit 327, etc. The contents module 330 relates to the space information for implementing the interaction between the real environment and the virtual contents, and includes a mixed reality simulator 331, a mixed space DB 332, a communication device 333, an external mixed space 334, an action generator 335, etc. The miniature AR module 340 is to visibly/audibly/touchably provide the interaction between the real environment and the virtual contents. To this end, the miniature AR module 340 includes an audible providing device 341, a visible providing device 342, a touchable providing device 343, etc. Examples of the audible providing device 341 include a speaker, and examples of the visible providing device 342 include a monitor, a projector, a table, etc. Examples of the touchable providing device 343 include an oscillator, a haptic device, etc.

In the interactive augmented reality system 100, a 3D scene is restored on a sketch and tracking elements are extracted. AR systems according to the related art use only 3D features. Therefore, hard coding by a developer results in difficulty in AR authoring, and tangibility is reduced due to a shadow or the occlusion phenomenon, etc. Further, tracking on blurred image is weak. In contrast, in the exemplary embodiment, in addition to 3D features, geometric models such as edges, flat surfaces, curved surfaces, etc., are used. Therefore, management and use of AR scenes in object units is easy and rapid AR authoring is possible. Further, the shadow or the occlusion phenomenon, etc., are resolved, thereby enhancing the tangibility, and the reliability of tracking is also improved.

In the interactive augmented reality system 100, contact-less passive interaction is analyzed on the basis of depth information. Since marker-based interaction according the related art is a limited form of interaction, it is difficult to apply the marker-based interaction to miniature AR which a number of visitors simultaneously use. Further, there is the inconvenience of always holding a paddle to show a marker and thus interaction is implemented restrictively and logically. In contrast, the exemplary embodiment can implement various forms of interaction, which do not require wearable devices, as the space-based interaction. Further, space information of the vicinity of a target object is analyzed, which makes differentiation from the existing tracking method possible. Moreover, the interaction is extendable and it is possible to implement the interaction intuitively.

In the interactive augmented reality system 100, the contents are authored with contents authoring tools based on a GUI (graphical user interface). In a contents authoring method according to the related art, only development experts can combine contents with miniatures by contents graft through the hard coding, a large amount of time is taken, and modification is extremely difficult. In contrast, in the exemplary embodiment, an easy GUI-based authoring tool is used, thereby capable of giving various motions to contents and intuitively adjusting the size, rotation, and movement. Further, modification is easy, and it is easy to graft various multimedia contents. Furthermore, animation control according to a story is possible and converting or editing of the contents is also possible.

The input information acquiring unit 110 performs a function of acquiring input information for the interaction between the real environment and the virtual contents in consideration of the planned story.

The virtual contents determining unit 120 performs a function of determining virtual contents according to the acquired input information.

The matching unit 130 performs a function of matching the virtual contents with the real environment by using the augmented position of the virtual contents acquired in advance. The matching unit 130 uses depth information of an acquired image or context information of the acquired image when matching the virtual contents. Further, the matching unit 130 may include an interaction analyzing unit in consideration that the interactive augmented reality system 100 analyzes depth-information-based contact-less passive interactions. In this case, the interaction analyzing unit performs a function of analyzing interactions between the real environment and the virtual contents on the basis of the depth information of at least one object positioned in the real environment.

The main control unit 140 performs a function of controlling the whole operation of the individual units constituting the interactive augmented reality system 100.

The interactive augmented reality system 100 may further include a virtual contents authoring unit 150. The virtual contents authoring unit 150 performs a function of authoring the virtual contents on the basis of a GUI (graphical user interface). When authoring the virtual contents, the virtual contents authoring unit 150 includes a virtual contents aligning unit 151 for aligning the virtual contents to be proportion to the sizes of objects in the real environment.

In order to resolve the occlusion phenomenon of the augmented virtual object, the shadow rendering, and the conflict between actual and virtual objects, a virtual model having the same size and shape as the actual object is necessary. The size and pose of the same virtual model as the actual object in the augmented environment should be accurately aligned to provide improved immersive realization.

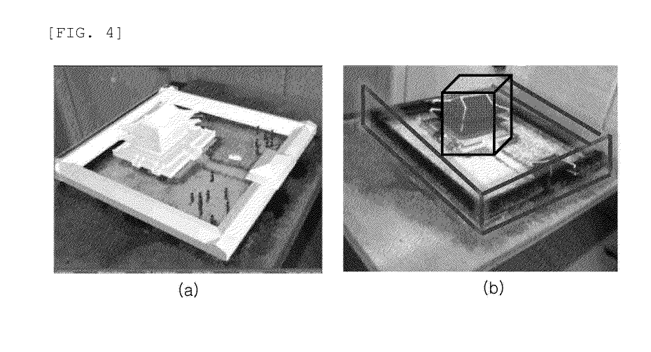

The user can use a regular tool to create the virtual model or directly insert rough box shapes to create the virtual model. In FIG. 4, (a) shows an example using a regular 3D authoring tool, and (b) shows an example modeled in a desired shape according to a user-defined method while seeing an image. The case of (b) can be implemented by inserting basic primitives into the image.

The virtual contents aligning unit 151 includes an augmented position setting unit, a virtual contents loading unit, a scale setting unit, and a pose setting unit. The augmented position setting unit performs a function of setting an augmented position of virtual contents. The virtual contents loading unit performs a function of loading the virtual contents to the set augmented position. The scale setting unit performs a function of determining a scale of the loaded virtual contents. The scale setting unit may set the scale to a value obtained by dividing a length of an edge of the virtual contents by a length of a corresponding edge of the actual object. The pose setting unit performs a function of determining the pose of the scaled virtual contents.

In this exemplary embodiment, the aligning process includes a first step of setting a 3D coordinate system (x, y, z) of a position to be augmented, a second step of loading a virtual object, a third step of setting a scale, a fourth step of manually setting a pose, and a fifth step of storing the scale and the pose. The first step sets the x, y, z coordinate system by fitting a restored 3D feature (x, y, z) of a concerned area into a plane. The third step is performed by designating a known straight line (side) with a mouse. For example, red lines in (b) of FIG. 4 can correspond thereto. In this case, the scale can be obtained by the following Equation 1.

$$\frac{Length of Edge of Virtual Model ( unit )}{ \begin{matrix}Length of Corresponding \\ Edge of Actual Object ( pixel )\end{matrix}} \qquad [ Equation 1 ]$$

The fourth step uses rotation and translation matrixes of the virtual model.

The interactive augmented reality system 100 may further include a position computing unit 160. The position computing unit 160 performs a function of computing the augmented position of the virtual contents in the acquired image on the basis of the feature.

The position computing unit 160 includes a feature detecting unit and a tracking unit. The feature detecting unit performs a function of detecting a feature by using color information of the acquired image. The tracking unit performs a function of tracking the position of an image acquiring device acquiring the image by using the edge information of the object or the 2D information of the object in addition to the feature.

The interactive augmented reality system 100 may further include a first feature matching unit 170 and a second feature matching unit 180. The first feature matching unit 170 performs functions of comparing the restored image regarding the real environment with the acquired image and matching the features through the comparison. The second feature matching unit 180 performs functions of comparing the acquired image with the previous image of the acquired image and matching the features through the comparison. In the exemplary embodiment, when the position computing unit 160 computes the augmented position of the virtual contents, the first feature matching unit 170 and the second feature matching unit 180 are driven at the same time.

The first feature matching unit 170 includes an object recognizing unit, a comparing unit, a recognition controlling unit, a pose computing unit, and an object information acquiring unit. The object recognizing unit performs functions of primarily recognizing at least one object having a scale equal to or greater than a reference value in the acquired image and secondarily recognizing at least one object having a scale less than the reference value in the acquired image. The comparing unit performs functions of adding the number of objects primarily recognized to the number of objects secondarily recognized and comparing the number of recognized objects with a predetermined limit value. The recognition control unit performs a function of making the object recognizing unit recognize objects in the acquired image one more time if the number of recognized objects is greater than the limit value. The pose computing unit performs a function of computing poses of the recognized objects by using the restored image when the number of recognized objects is not greater than the limit value. The object information acquiring unit performs a function of acquiring information on objects corresponding to inliers among the objects having been subject to the position computation according to a coordinate system generating algorithm based on RANSAC (random sample consensus).

The second feature matching unit 180 includes a determining unit, a feature matching unit, a comparing unit, a pose computing unit, an image acquisition control unit, and an object information acquiring unit. The determining unit performs a function of determining whether an object acquired in advance is in the acquired image. The feature matching unit performs a function of matching the features on the basis of a SIFT (scale invariant feature transform) algorithm when an object acquired in advance is in the acquired image. The comparing unit performs a function of comparing the number of matched features with a reference value. The pose computing unit performs a function of computing the pose of the image acquiring device acquiring the image by using a previous image when the number of matched features is equal to or greater than the reference value. When any object acquired in advance is not in the acquired image or the number of matched features is less than the reference value, the image acquisition control unit performs a function of making the image acquiring device acquire an image again. The object information acquiring unit performs a function of acquiring information on the objects corresponding to the inliers in the acquired image by the image acquiring device having been subject to the pose computation.

In order to acquire in real time the pose of the camera expressed by rotation and translation matrixes, 3D geometric information of the miniature is required. In the exemplary embodiment, the 3D geometric information, 3D coordinates of the features, and patch information are restored in advance by using several photographs of the miniature. In the process of restoring the miniature by using the adjusted camera, in order for strong matching of the rotation, scale, and noise of the image, SIFT (scale invariant feature transform) features are used. In the 3D restoration process of the whole miniature, image acquisition, detection of features according to SIFT, initial image selection, initial image restoration, additional image restoration, nonlinear bundle adjustment, parameter arrangement for 3D tracking, etc. are sequentially performed.

After the 3D restoration, a coordinate system for tracking is generated by using the features of the generated miniature. The features existing in positions where a coordinate system will be generated are collected and the features are fitted into a plane. Since 3D features generated in the 3D restoration process include noise, a strong coordinate system generating algorithm based on RANSAC (random sample consensus) is performed.

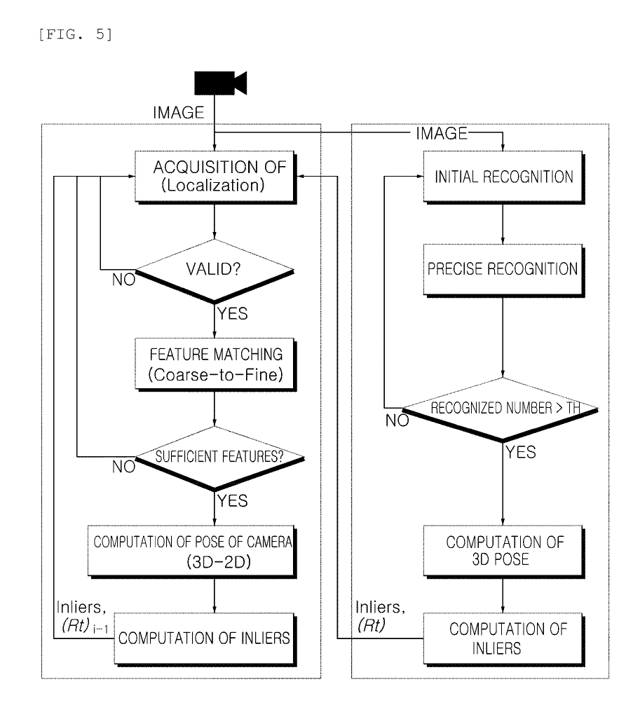

The position of the camera is computed in real time by using information of the 3D restored miniature. To this end, real-time recognition of 3D features and points currently observed from a camera 2D image is required. Since the SIFT features are used in the restoration process, in a case in which real-time SIFT features are detected from the 2D image, the real-time matching of the 3D features is possible. However, since the SIFT algorithm does not ensure a real-time property in the current computing environment, in order to supplement this, in the exemplary embodiment, multi core programming is used. That is, a 3D feature recognizing module and a camera tracking module are separate from each other and are executed in corresponding individual cores at the same time. Conclusively, the programming is used to achieve a camera tracking computation rate equal to or greater than 30 frames per second. FIG. 5 is a flow chart illustrating a proposed algorithm including a tracking thread and a recognizing thread. In the tracking thread, the features recognized from the previous image are matched to the current image. In the recognizing thread, matching of the SIFT features of the miniature stored in the restoration process and the SIFT features of the current image is performed.

In the exemplary embodiment, the interaction is implemented by the input information acquiring unit 110, the virtual contents determining unit 120, the matching unit 130, etc. The 3D spatial interaction uses dense depth information acquired in miniature space. The depth camera is installed on the system, and depth variation of the space related to the miniature is observed for every frame. However, since variation of the whole space cannot be sensed, an approach of inserting a virtual interaction sensor into local space is used.

A general-depth-based 3D interaction interface flow chart is performed in order of projection using N-number of space sensors and matching information, occupation check using depth information acquisition, interaction analysis, etc.

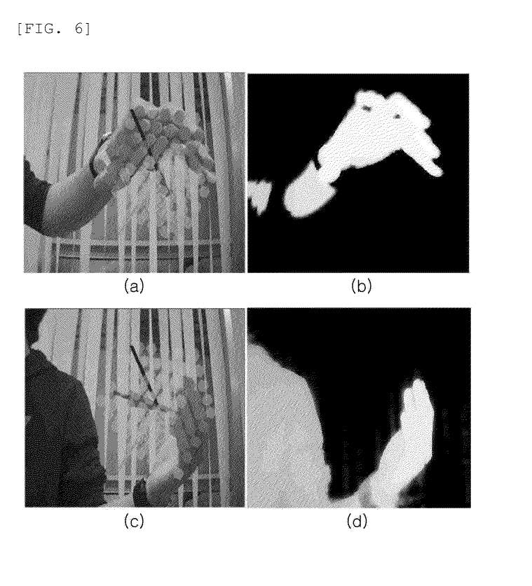

A depth-based 3D spatial interaction interface provides a 3D interaction interface by using space sensors disposed in 3D space. The space sensors are not physical sensors but virtual sensors which are disposed in virtual space, and 3D information of real space acquired by using an infrared-based z-cam capable of recognizing depth values and information of virtual space are matched to check the occupation state of the space sensor. The occupation state of the space sensor is checked by projecting the space sensor of the virtual space onto a depth map using the matching information and comparing the depth value of the projected space sensor and the depth value on the depth map. The 3D spatial interaction interface is configured by combining a number of space sensors and becomes a basic analysis unit regarding input of the user. One analysis unit is analyzed in different meanings according to analysis units such as the order and direction in which a number of space sensors are occupied, the size of occupied area, etc., and serves as a direct interface for input of the user. FIG. 6 shows interaction results. As shown in (a) and (c) of FIG. 6, 3D space is defined by a sensor, and information necessary for interaction is acquired by performing checking of conflict between a hand and the sensor in real time and is analyzed. In FIG. 6, (b) and (d) show extracted depth map images.

In order to implement an actual system, a computer with core 2 duo CPU 2.66 GHz and nVidia GTX 280 is used. A Flea (Point Grey Research, Inc) is used as the camera. Images having a resolution of 640×480 can be acquired maximally at a rate of 60 frames per second. A z-cam is used as the depth camera. Depth maps having a resolution of 320×240 can be acquired maximally at a rate 30 frames per second with the camera using the infrared. The algorithm is implemented by using OpenCV library for matrix operation and image process and OpenSceneGraph which is a rendering engine for implementing augmented reality. Scene Graph based 3D space can be managed by combining OpenSceneGraph and a marker-less tracking algorithm, and there is an advantage in which various functions provided by OpenSceneGraph can be used together.

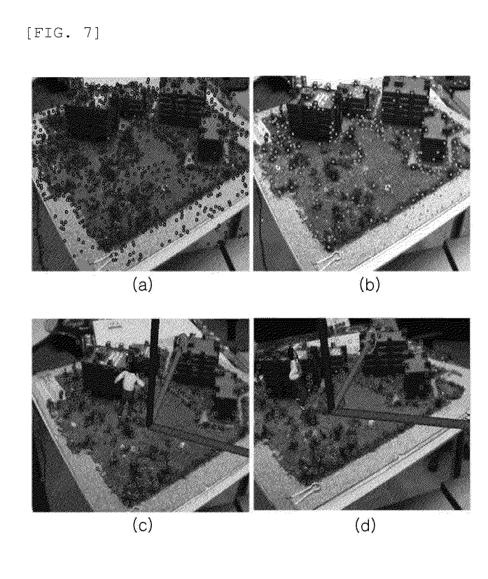

FIG. 7 is a view illustrating results obtained by augmenting a virtual avatar using 3D restoration and marker-less tracking results. In FIG. 7, (a) shows SIFT features which are 3D restored from the miniature for maker-less tracking. In FIG. 7, (b) shows a process of setting an augmented real coordinate system from the 3D restored features. The user collects arbitrary plane features and fits them into a plane. The generated coordinate system and a virtual avatar composed on the basis of the coordinate system are as shown in (c) and (d) of FIG. 7.

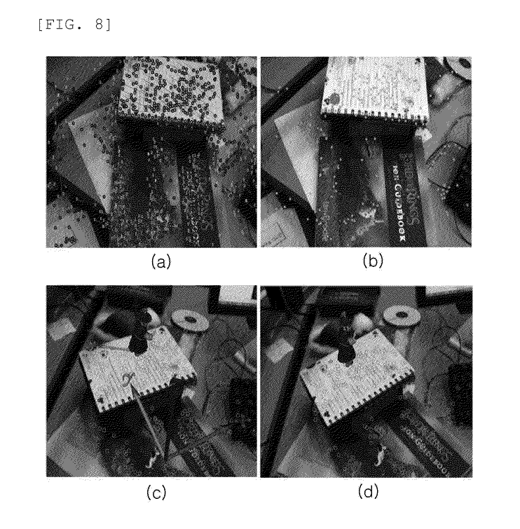

FIG. 8 is a view illustrating an example in which a plurality of augmented reality coordinate systems are generated in the real world by extending a marker-less tracking algorithm applied to miniature AR. Plane information in real space is extracted from 3D features as shown in (b) of FIG. 8, and coordinate systems are generated on two planes. Results obtained by independently augmenting individual virtual avatars in the individual coordinate systems are as shown in (c) and (d) of FIG. 8.

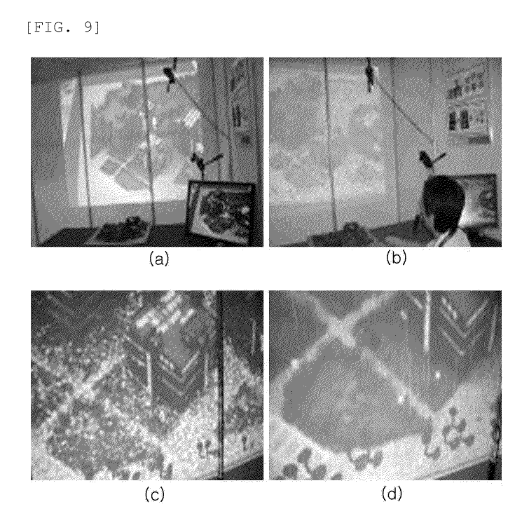

FIG. 9 is a view illustrating a procedure of demonstrating a proposed miniature AR system in a real show. In the show, weather changes simulated in a miniature can be experienced by a user. In FIG. 9, (a) and (b) show a whole system and a situation in which the user is operating contents, and (c) and (d) show simulation results of a case where it is snowing and a case where it is raining in augmented reality, respectively.

As described above, the miniature AR system to which the maker-less real-time tracking technology and the depth-based spatial interaction method are applied by the interactive augmented reality system 100 according to the exemplary embodiment has been proposed. The proposed miniature AR system is an augmented-reality-based next-generation digilog-type contents experience system, and the user can directly experience digilog type contents in a natural manner. The system provides more improved system construction interface as compared to existing marker-less systems and provides a tracking performance of 30 frames or more per second, thereby constructing ceaseless augmented reality. Further, the proposed depth-camera-based spatial interaction approach makes natural interaction between the user and the virtual contents possible in marker-less augmented reality.

Meanwhile, the feature detecting unit included in the position computing unit 160 can selectively detect the features in uniform spaces on the basis of observation probabilities. This will be described below.

In general, in order to compute the pose of the camera from 3D space, the coordinates of the features in the 3D space and 2D image points projected onto an image plane are required. The real-time camera tracking is a process of tracking 3D-2D matching relationship in real time. In the exemplary embodiment, a method of rigidly restoring the pose of the camera while ensuring the real-time property when a large amount of 3D information generated off-line is provided will be described. First, images of space are acquired off-line and SIFT (scale invariant feature transform) features are detected from them. 3D coordinates of the features and a SIFT descriptor for matching are generated by image-based 3D restoration technology. When the restored SIFT features are used for real-time camera tracking as they are, it is difficult to ensure the real-time property because the amount of data and high CPU requirement. In order to overcome this, the restored SIFT features are uniformly divided in the 3D space, and only features having high probabilities that they will be shown are selected as key points for every area. In order for rapid matching of them, the features are stored for every tree level by using an octree structure. The features selected and stored from the uniform areas are sequentially used for real-time matching, and are used to determine a precise area having high possibility, and an extended matching process is finally performed. When the proposed method is applied to 3D space composed of about 80 key frames, the pose of the camera is obtained within 6 to 10 ms with 640×480 images.

The above statement will be described below in detail.

Recently, image-based feature recognition and camera tracking technology performs an important function in implementing marker-less augmented reality applications. In the exemplary embodiment, a method of effectively recognizing 3D space and tracking the 6DOF pose of a camera in real time is proposed. In order to perform recognition and tracking in 3D space, 3D coordinate information of a scene and feature information corresponding thereto are required. For this, in the exemplary embodiment, 3D space is restored off-line, and key SIFT features in the restored space are selected in uniform spaces on the basis of observation probabilities. During real-time camera tracking, matching is performed by using the selected features, and the matching is performed in camera FOV (field of view) area estimated using information of positions in camera space. Therefore, even though a large area is restored off-line and thus feature data increases, the camera tracking speed is not greatly influenced.

The general process of the feature recognition and tracking is as follows. A framework is composed of an off-line mode and an on-line mode. In the off-line mode, image-based modeling is performed and tracking data are selectively stored. In summary, the off-line mode includes a step of detecting SIFT features from a plurality of images, a step of performing 3D restoration, a step of selecting key points, etc. The on-line mode uses a two-thread-based multi core programming approach to detect the pose of the camera in real time. A SIFT recognition process is preformed in the background, and the recognized key points are tracked by an affine-warping-based tracking algorithm so as to provide reliable results. In summary, the on-line mode is divided into a main thread and a background thread. The main thread includes a step of tracking key points from images acquired by the camera, a step of computing the pose of the camera, a step of rendering contents, etc. The background thread includes a step of detecting SIFT features of the images acquired by the camera, a step of matching the key points, a step of estimating a key point recognition area, etc.

In a case of using all key points generated after 3D restoration to perform tracking, the increase of the matching features causes the remarkable degradation of the function in a wide area. In order to resolve this, in the exemplary embodiment, features which are 3D restored are implemented in octree. According to tree levels (1, . . . , and m), the 3D space is divided into N₁, . . . , and Nₘ sizes. Only features having the highest observation frequency in the divided areas are selected and stored. A key point set detected at level 1 is referred to as L_{k,l}. ‘m’ is determined by the number of features finally restored, and does not exceed 5. Thereafter, in order for a rapid feature matching process, the features belonging to the individual areas are stored by using k-dTree.

Matching is performed in the order from detected L_{k,l} to the highest tree level. The tree matching determines that an area has a high probability that it will be recognized when a specific condition is satisfied. That is, most of features of space irrelevant to the matching process of areas belonging to a specific level can be eliminated. The area determined to have a high matching probability is compared to features detected from the camera images by using k-dTree stored in advance, thereby obtain precise matching results.

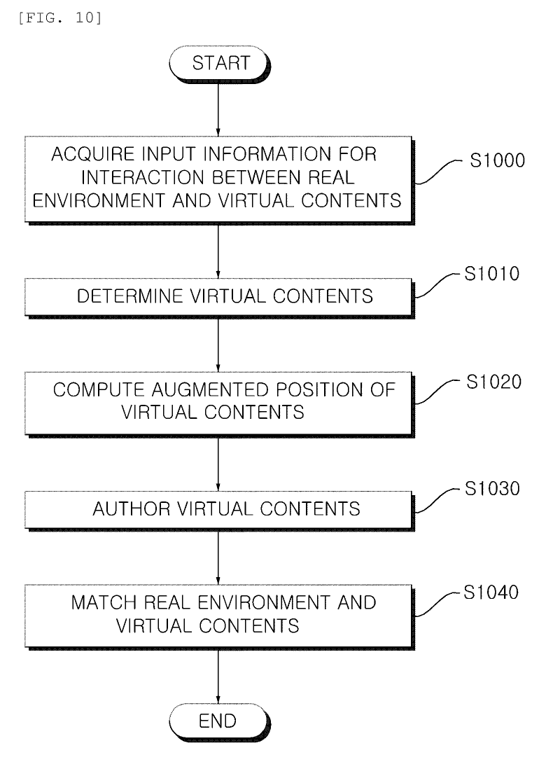

Next, a method of implementing the interaction in augmented reality by using the interactive augmented reality system 100 will be described. FIG. 10 is a flow chart illustrating a method of implementing interaction in augmented reality according to an exemplary embodiment of the present invention. Hereinafter, description will be made with reference to FIG. 10.

First, the input information acquiring unit 110 acquires input information for the interaction between real environment and virtual contents in consideration a planned story (S1000).

Next, the virtual content determining unit 120 determines virtual contents according to the acquired input information (S1010).

Then, the position computing unit 160 computes an augmented position of the virtual contents on the basis of features in an acquired image (S1020). In this case, a step of allowing the first feature matching unit 170 to compare a restored image regarding the real environment and the acquired image and perform feature matching through the comparison, a step of allowing the second feature matching unit 180 to compare the previous image of the acquired image and the acquired image and perform feature matching through the comparison, etc., may be performed together. When the position computing unit 160 computes the augmented position of the virtual contents, the two feature matching steps may be performed at the same time.

In the exemplary embodiment, the feature matching step of the first feature matching unit 170 may include a step of allowing the object recognizing unit to primarily recognize at least one object having a scale equal to or greater than a reference value in the acquired image and secondarily recognize at least one object having a scale less than the reference value in the acquired image, a step of allowing the comparing unit to compare the number of recognized objects obtained by adding the number of primarily recognized objects to the number of secondarily recognized objects with a predetermined limit value, a step of allowing the recognition control unit to make the object recognizing unit recognize objects again when the number of recognized objects is greater than the limit value, a step of allowing the pose computing unit to compute the poses of the recognized objects by using the restored image when the number of recognized objects is not greater than the limit value, a step of allowing the object information acquiring unit to acquire information on objects corresponding to inliers among the objects, on which pose computation has been performed, according to a RANSAC (random sample consensus) based coordinate system generating algorithm, etc.

Further, in the exemplary embodiment, the feature matching step of the second feature matching unit 180 may include a step of allowing the determining unit to determine whether an object acquired in advance is in the acquired image, a step of allowing the feature matching unit to perform feature matching on the basis of an SIFT (scale invariant feature transform) algorithm when an object acquired in advance is in the acquired image, a step of allowing the image acquisition control unit to make the image acquiring device for acquiring images acquire an image again when any object acquired in advance is not in the acquired image, a step of allowing the comparing unit to compare the number of matched features is equal to or greater than a reference value, a step of allowing the pose computing unit to compute the pose of the image acquiring device by using a previous image when the number of matched features is equal to or greater than the reference value, a step of allowing the image acquisition control unit to make the image acquiring device acquire an image again when the number of matched features is less than the reference value, a step of allowing the object information acquiring unit to acquire information on objects corresponding to inliers in the acquired image according to the image acquiring device on which pose computation has been performed, etc.

Meanwhile, the position computing unit 160 may use the feature detecting unit and the tracking unit when computing the augmented position of the virtual contents. In this case, the feature detecting unit detects the features by using the color information of the acquired image, and the tracking unit tracks the position of the image acquiring device acquiring the image by using edge information of objects or 2D information of the objects in addition to the features. The feature detecting unit can selectively detect features on the basis of observation probabilities in uniform spaces.

Meanwhile, the step S1020 of computing the augmented position of the virtual contents can be omitted in the exemplary embodiment.

Next, the virtual contents authoring unit 150 authors the virtual contents on the basis of GUI (graphical user interface) (S1030). The virtual contents authoring unit 150 aligns the virtual contents to be proportion to the sizes of objects in the real environment when authoring the virtual contents. Specifically, the aligning of the virtual contents may include a step of allowing the augmented position setting unit to set the augmented position of the virtual contents, a step of allowing the virtual contents loading unit to load the virtual contents to the set augmented position, a step of allowing the scale setting unit to determine a scale of the loaded virtual contents, a step of allowing the pose setting unit to determine the pose of the scaled virtual contents, etc. In particular, the step of determining the scale of the virtual contents may determine the scale to a value obtained by dividing a length of an edge of the virtual contents by a length of a corresponding edge of the actual object.

Meanwhile, the step S1030 of authoring the virtual contents can be omitted in the exemplary embodiment.

Next, the matching unit 130 matches the virtual contents with the real environment by using the augmented position of the virtual contents acquired in advance (S1040). The matching unit 130 uses depth information of the acquired image or context information of the acquired image when matching the virtual contents.

Meanwhile, the exemplary embodiments of the present invention described above may be made in a program executable in a computer, and be implemented in a general-purpose digital computer executing the program by using a recording medium readable by a computer. Examples of the recording medium readable by a computer include magnetic storing media (for example, ROM, floppy disks, hard disks, magnetic tapes, etc.), optically readable media (for example, CD-ROM, DVD, optical-data storing devices, etc.), and storing media such as carrier waves (for example, transmission through Internet).

Although the technical spirit or scope of the present invention has been described for illustration, those skilled in the art can make various modifications, variations, and substitutions within a range without deviating from the essential characteristics of the present invention. Therefore, the exemplary embodiments of the present invention and the accompanying drawings are used in a generic and descriptive sense only and not for purposes of limitation of the spirit or scope of the present invention. The scope of the invention should be determined by appended claims and all of the technical spirits or scopes in the equivalent range should be included in the scope of the present invention.

The present invention relates to a real-time interactive system and method regarding interactive technology between miniatures in real environment and digital contents in virtual environment, and a recording medium storing a program for performing the method. A user can interact with 3D virtual contents matched with actual miniatures by using hands without arbitrary tools (e.g. a tool with a maker), and improved immersive realization can be obtained by augmentation using natural features. The present invention can be used for story telling using a digilog-type contents experience system and augmented reality technology in a showroom, and the detail techniques can be used together with other fields (for example, robot navigation) in the existing augmented reality field.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. An interactive augmented reality system comprising:
an input information acquiring unit acquiring input information for an interaction between real environment and virtual contents in consideration of planned story;
a virtual contents determining unit determining the virtual contents according to the acquired input information; and
a matching unit matching the real environment and the virtual contents by using an augmented position of the virtual contents acquired in advance.

2. The interactive augmented reality system according to claim 1, further comprising:
a virtual contents authoring unit authoring the virtual contents on the basis of GUI (graphical user interface).

3. The interactive augmented reality system according to claim 2, wherein:
the virtual contents authoring unit includes a virtual contents aligning unit aligning the virtual contents to be proportion to the sizes of objects in the real environment when authoring the virtual contents.

4. The interactive augmented reality system according to claim 3, wherein:
the virtual contents aligning unit includes
an augmented position setting unit setting the augmented position,
a virtual contents loading unit loading the virtual contents to the set augmented position,
a scale setting unit determining a scale of the loaded virtual contents, and
a pose setting unit determining the pose of the virtual contents on which the scale setting has been performed.

5. The interactive augmented reality system according to claim 1, wherein:
the matching unit includes an interaction analyzing unit analyzing the interaction between the real environment and the virtual contents on the basis of depth information of at least one object positioned in the real environment.

6. The interactive augmented reality system according to claim 1, further comprising:
a position computing unit computing the augmented position on the basis of features in an acquired image.

7. The interactive augmented reality system according to claim 6, further comprising:
a first feature matching unit comparing a restored image regarding the real environment and the acquired image and performing feature matching through the comparison, and
a second feature matching unit comparing the previous image of the acquired image and the acquired image and performing feature matching through the comparison,
wherein, when the position computing unit computes the augmented position, the first feature matching unit and the second feature matching unit are driven at the same time.

8. The interactive augmented reality system according to claim 7, wherein:
the first feature matching unit includes
an object recognizing unit primarily recognizing at least one object having a scale equal to or greater than a reference value in the acquired image and secondarily recognizing at least one object a scale less than the reference value in the acquired image,
a comparing unit adding the number of objects primarily recognized to the number of objects secondarily recognized and comparing the number of recognized objects with a predetermined limit value,
a recognition control unit making the object recognizing unit recognize objects in the acquired image one more time if the number of recognized objects is greater than the limit value,
a pose computing unit computing poses of the recognized objects by using the restored image if the number of recognized objects is not greater than the limit value, and
an object information acquiring unit acquiring information on objects corresponding to inliers among the objects on which the pose computation has been performed according to a coordinate system generating algorithm based on RANSAC (random sample consensus).

9. The interactive augmented reality system according to claim 7, wherein:
the second feature matching unit includes
a determining unit determining whether an object acquired in advance is in the acquired image,
a feature matching unit performing feature matching on the basis of an SIFT (scale invariant feature transform) algorithm if an object acquired in advance is in the acquired image,
a comparing unit comparing the number of matched features with a reference value,
a pose computing unit computing a pose of an image acquiring device for acquiring images by using a previous image if the number of matched features is equal to or greater than the reference value,
an image acquisition control unit performs a function of making the image acquiring device acquire an image again if any object acquired in advance is not in the acquired image or the number of matched features is less than the reference value, and
an object information acquiring unit acquiring information on objects corresponding to inliers in the acquired image by the image acquiring device on which the pose computation has been performed.

10. The interactive augmented reality system according to claim 6, wherein:
the position computing unit includes
a feature detecting unit detecting the features by using color information of the acquired image or selectively detecting the features in uniform spaces on the basis of observation probabilities, and
a tracking unit tracking the position of an image acquiring device for acquiring images by using edge information of objects or 2D information of the objects in addition to the features.

11. The interactive augmented reality system according to claim 1, wherein:
the matching unit uses depth information of an acquired image or context information of the acquired image when matching the virtual contents.

12. A method of implementing an interaction in augmented reality comprising:
(a) acquiring input information for an interaction between real environment and virtual contents in consideration of a planned story;
(b) determining the virtual contents according to the acquired input information; and
(c) matching the real environment and the virtual contents by using an augmented position of the virtual contents acquired in advance.

13. The method of implementing an interaction in augmented reality according to claim 12, further comprising:
(b1) authoring the virtual contents on the basis of GUI (graphical user interface) between the (b) and the (c).

14. The method of implementing an interaction in augmented reality according to claim 13, wherein:
the (b1) aligns the virtual contents to be proportion to the sizes of objects in the real environment when authoring the virtual contents

15. The method of implementing an interaction in augmented reality according to claim 14, wherein:
the aligning of the virtual contents in the (b1) includes
(b11) setting the augmented position,
(b12) loading the virtual contents to the set augmented position,
(b13) determining a scale of the loaded virtual contents, and
(b14) determining the pose of the virtual contents on which the scale setting has been performed.

16. The method of implementing an interaction in augmented reality according to claim 12, further comprising:
(b1) computing the augmented position on the basis of features in an acquired image between the (b) and the (c).

17. The method of implementing an interaction in augmented reality according to claim 16, wherein:
the (b1) includes
(b11) comparing a restored image regarding the real environment and the acquired image and performing feature matching through the comparison, and
(b12) a second feature matching unit comparing the previous image of the acquired image and the acquired image and performing feature matching through the comparison, and
computes the augmented position.

18. The method of implementing an interaction in augmented reality according to claim 17, wherein:
the (b11) includes
(b11a) primarily recognizing at least one object having a scale equal to or greater than a reference value in the acquired image and secondarily recognizing at least one object a scale less than the reference value in the acquired image,
(b11b) adding the number of objects primarily recognized to the number of objects secondarily recognized and comparing the number of recognized objects with a predetermined limit value,
(b11c) making the object recognizing unit recognize objects in the acquired image one more time if the number of recognized objects is greater than the limit value, and computing poses of the recognized objects by using the restored image if the number of recognized objects is not greater than the limit value, and
(b11d) acquiring information on objects corresponding to inliers among the objects on which the pose computation has been performed according to a coordinate system generating algorithm based on RANSAC (random sample consensus).

19. The method of implementing an interaction in augmented reality according to claim 17, wherein:
the (b12) includes
(b12a) determining whether an object acquired in advance is in the acquired image,
(b12b) performing feature matching on the basis of an SIFT (scale invariant feature transform) algorithm if an object acquired in advanced is in the acquired image, and making the image acquiring device for acquiring images acquire an image again if any object acquired in advance is not in the acquired image,
(b12c) comparing the number of matched features with a reference value,
(b12d) computing a pose of the image acquiring device by using the previous image if the number of matched features is equal to or greater than the reference value, and making the image acquiring device acquire an image again if the number of matched features is less than the reference value, and
(b12e) acquiring information on objects corresponding to inliers in the acquired image by the image acquiring device on which the pose computation has been performed.
